(19) United States
(12) Patent Application Publication
(10) Pub. No.: US 2007/0201384 A1
(43) Pub. Date: Aug. 30, 2007

(54) Network explorer

(75) Inventors: Aaron Cunningham, Redmond, WA (US); Marieke I. Watson, Redmond, WA (US); Patrice L. Miner, Kirkland, WA (US); Alexandru Gavrilescu, Redmond, WA (US); Haiyong Wang, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/364,624

(22) Filed: Feb. 28, 2006

(51) Int. Cl. H04L 12/28

(52) U.S. Cl. 370/254

(57) ABSTRACT

A graphical user interface integrates into a single view multiple network devices discovered over a plurality of network protocols. The graphical user interface provides an intuitive user interface to indicate to a user the existence of all potential resources as defined by a network profile, the characteristics and properties of the resources via the representation of the device, and an interaction process specific to each discovered device that is customizable and extensible.

### BACKGROUND

Existing network browser systems typically use a single protocol at a time to detect and discover network devices. Often times however, a network device such as a printer, scanner, server, or terminal computer may use a different network protocol to communicate over a network and may be undetectable using a non-compatible protocol. Even if more than one protocol may be used for discovery, some systems may only list network devices based on the network protocol used to discover them, requiring a user to perform additional configuration steps to display other devices on a network using another protocol.

Alternatively, if multiple protocols are used to discover and display a more inclusive listing of network devices, there may not be a convenient interface for constraining the view of discovered devices to a set useful for a user. For example, the discovery process may list devices that a user does not consider part of a particular network. An intelligent management of the presentation of devices resulting from an inclusive discovery process may align user interest and expectation with device listing.

Furthermore, because of inconsistency in the information available on devices using different protocols, browsing systems may provide only a uniform representation of each discovered device, thereby sacrificing an opportunity to provide device specific information for consistency, and further reducing presentation utility.

### SUMMARY

A graphical user interface integrates into a single view, multiple network devices discovered over a plurality of network protocols providing an intuitive user interface for indicating the existence of potentially accessible network resources based on a network profile definition.

In one embodiment, representation of the network devices may be reflective of the state of the network device. This representation may change dynamically based on device state changes. The representation may be customized by the manufacturer via a device registry in accordance with an embodiment of the claims.

In one embodiment, a customized interaction process may be presented to the user via a context menu that is based on the state of the device and is specific to the device or device type. Multiple different interaction scenarios may be initiated using the context menu. Scenarios may be based upon type, customization, connection, and other properties of the device. Additional embodiments are described.

### DRAWINGS

FIG. 1 illustrates a block diagram of a computing system that may operate in accordance with the claims;

FIG. 2 illustrates a unifying API over several discovery protocols;

FIG. 3 illustrates a possible user network;

FIG. 4 illustrates a screen shot of a possible view of the claimed browser;

FIG. 5 illustrates a component diagram for enabling the claimed method and system;

FIG. 6 illustrates a register that may be used to provide customization and extensibility features of the claimed system;

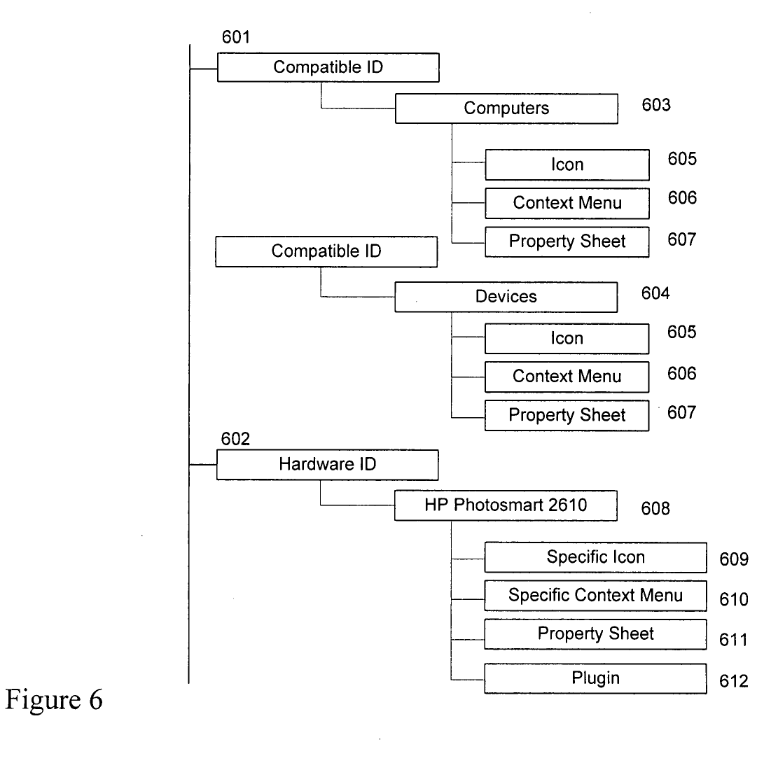

FIG. 7 illustrates a process flow of the claimed method and system; and

FIG. 8 illustrates a device context menu.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

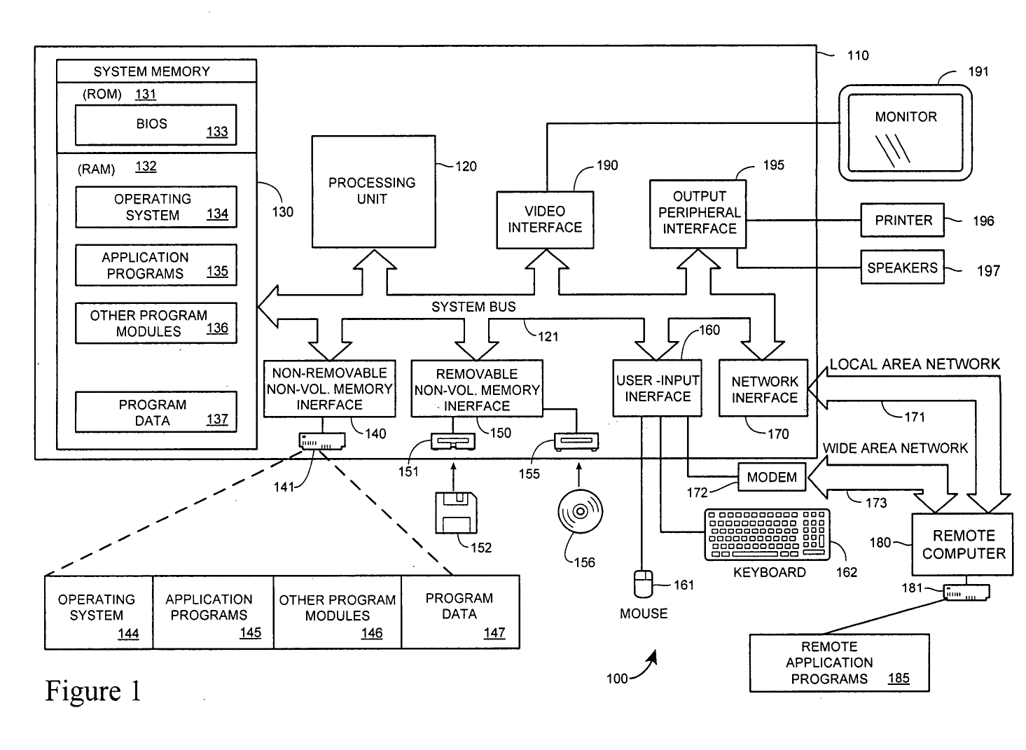

FIG. 1 illustrates an example of a suitable computing system environment 100 on which a system for the blocks of the claimed method and apparatus may be implemented. The computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

The blocks of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The blocks of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media may be any available media that may be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components may either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections illustrated are exemplary and other means of establishing a communications link between the computers may be used.

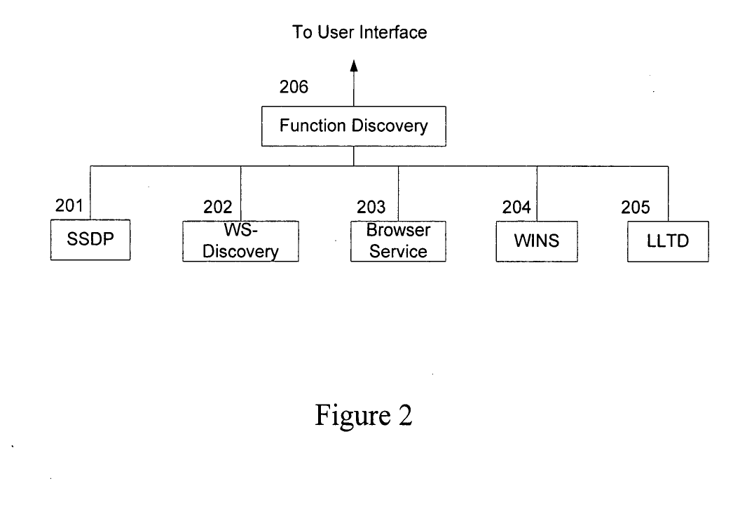

FIG. 2 illustrates that several different discovery protocols may be used to detect devices on a network. A few of these discovery protocols include Simple Service Discovery Protocol (SSDP) 201, Web Services Discovery (WS-Discovery) 202, Master Browser over NetBIOS 203, WINS (Windows Internet Naming Service) 204 and Link Layer Topology Discovery (LLTD) 205. Unfortunately, not every device on a network may be detectable using a single protocol, and thus, using a single protocol may not provide an inclusive collection of network devices. A more inclusive discovery process may use multiple protocols to perform device discovery. However, using multiple protocols alone does not necessarily improve user browser experience. For example, some existing browser systems may only display a partial list of possible network devices based on a selected network protocol used to discover that partial list, requiring a user to perform additional configuration steps to display other devices on the same network using another protocol. This may be burdensome and counter intuitive. A unifying application program interface (API), such as a Function Discovery component 206, may be provided to coordinate communications over multiple protocols and providing an inclusive discovery result.

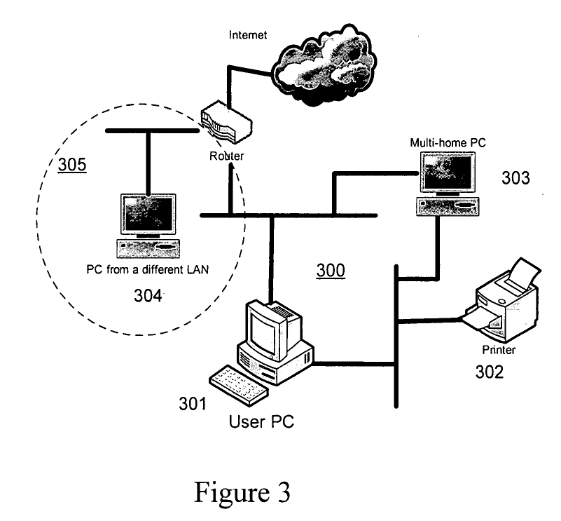

While a Function Discovery component may expand network discovery, a result set that is too large may also detract from a clear presentation. For example, a discovery process may extend past a user's expected discovery scope and provide a device listing that is not entirely useful for a user. This may happen when a user is presented a large list of devices, not all of which a user considers as part of his immediate network. For example, FIG. 3 illustrates a local area network (LAN) 300 connected to a user PC 301. A discovery process may detect printer 302, PC 303, and PC 304. However, a user may not be interested in PC 304, because it is outside the user's perceived network, e.g., it may be on a different LAN 305.

The claimed method and system may use a network profile to help define the set of devices presented to a user in a browser system. A network profile may be a collection of network signatures, where a network signature may correspond to a section of a network identified by the user machine for a particular connection. If a computer has a single network interface, e.g., a single network interface card (NIC), each time the NIC is connected to a different port on a network, a new network signature may be generated by the user computer for keeping track of network connections. Alternatively, if a computer has two NICs, then each NIC connected to a network may have a different network signature. Thus, every access point that a computer connects to may have a unique network signature. Further, the network signature is associated with a collection of devices discovered for that connection, thereby defining a set of discovered devices and identifying a network. A heuristic mechanism may then be employed to refine a network profile definition by using rule sets and user feedback. For example, a heuristic mechanism may be used to determine whether two network signatures belong to the same network, thereby providing a method of determining whether a particular connection provides access to the same network as another connection. In a more specific example, a heuristic mechanism may determine that two network signatures are part of the same network. Accordingly, the two signatures may be associated with the same network profile. This may be performed by adding the network signature for the second interface to an existing network profile containing a first signature for the first interface. Heuristic methods and means are discussed in depth further in this application.

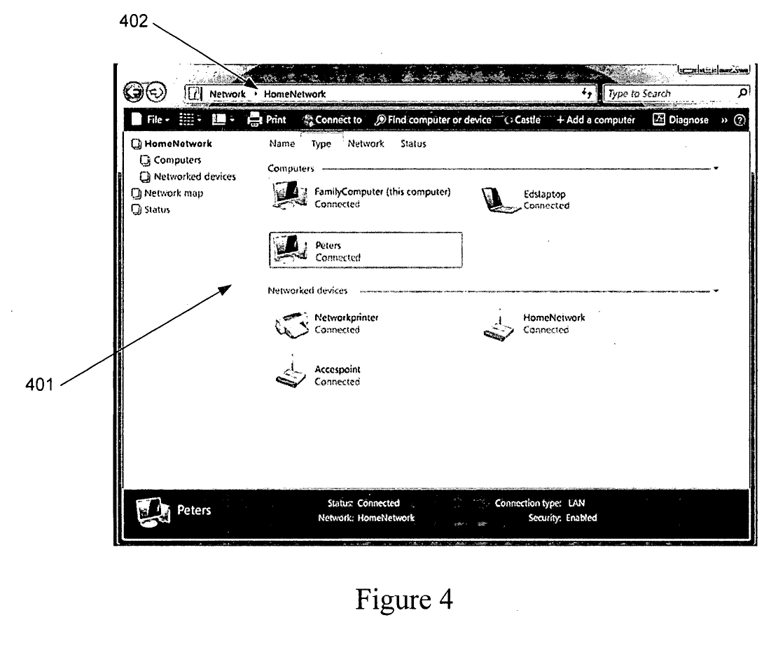

Network profiles and network signatures may enable a browser, hereinafter referred to as a network explorer, to display a set of discovered network devices in an organized and useful manner, as illustrated in FIG. 4. Discovered devices may be aggregated on a per network profile basis. FIG. 4 illustrates an embodiment of a view of network explorer where a list format 401 may be used to present the discovered devices on a network. Thus, if a single computer is plugged into the same network at different access points, only a single network profile may be presented to the user. The network profiles may be labeled using user friendly names such as “HomeNetwork,” “Office,” “Coffee Shop,” etc. In a simple form, the view may include a network profile drop down menu 402 (which may display a listing of network profiles such as “HomeNetwork,” “Office,” and “Coffee Shop,” when the menu is selected) along with a listing of devices 401 for that network profile. Displaying a set of devices belonging to a network profile may then appear as a set of all devices accessible to a user for a particular connection at a particular time.

In an alternative situation, if two adapters (NICs) are connected to the same network, the union of the devices discovered over those adapters may be displayed as one network profile. Thus, in instances when a user is connected to a “Work” profile via two different interfaces, e.g., wired and wireless interfaces, the browser may present only one network profile, “Work,” which includes all devices accessible for that profile. If it is determined that two connection points, or interfaces, connect to different networks or network profiles, then devices for each network profile may be presented separately, e.g., two network profiles will be listed separately in the drop down menu 402. In this embodiment, topology information may not be presented, only a device listing. In alternative embodiments, an enumeration of devices with topology information may be displayed, wherein the presentations of each device may be consistent with the list view.

As discussed above, heuristic mechanisms may be used to help define the network signature. These heuristics may provide a best guess based on various different network parameters and, like most heuristic processes, be refined via user feedback. The heuristic mechanisms may involve using discovery protocols that recognize subnet boundaries based on packet information or based on network segmentation as indicated by intermediate devices such as routers, hubs, and gateways. For example, a heuristic process may determine whether a DNS suffix of a subnet used by a set of discovered devices is similar or whether the MAC address of a detected default gateway between two connections is the same, thereby implying the same network. It should be noted that the heuristic methods described are only some examples of possible heuristic mechanisms that may be employed.

When a heuristic mechanism incorrectly identifies a network profile, a user may adjust or correct the network profile definition, thereby providing the heuristic mechanism feedback for use in future decisions. For example, in the case where two network signatures are determined to be on the same network, but a few additional devices are associated with one signature but not the other, a heuristic mechanism may guess that those devices should not be included in the same network profile and additionally prompt a user to verify or revoke that decision.

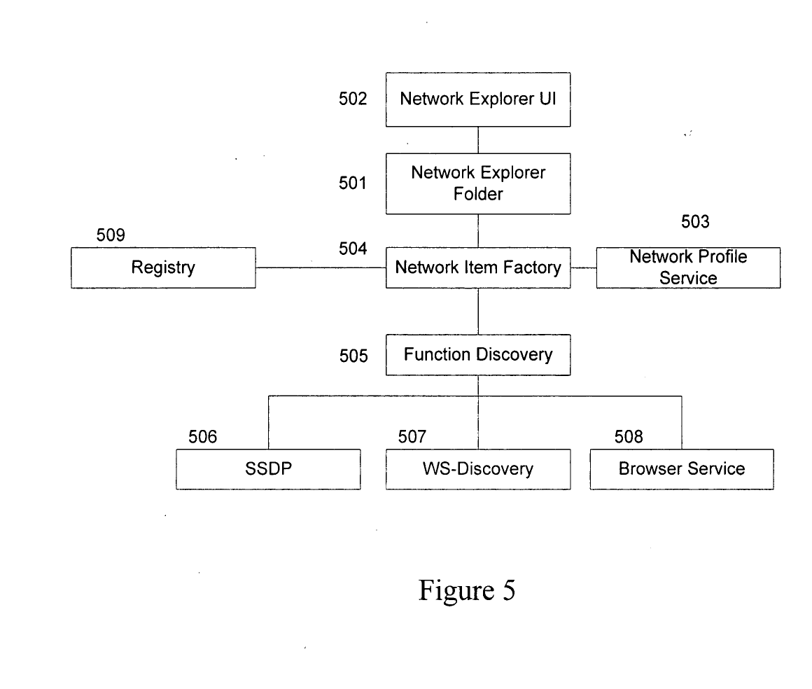

FIG. 5 illustrates a component diagram of an embodiment of the claimed network explorer. The following components are illustrated:

Function Discovery (FD) 505 may be a common API that performs device discovery across multiple protocols 506, 507, 508 and that provides an inclusive result set. Function Discovery 505 may provide a listing of function instances. Each function instance may include a set of identifiers for a device discovered on a network.

A Device Extensibility Registry 509 may be used to provide device specific information or a reference to a Device Plugin (e.g., a COM component) that may be able to provide device specific information.

Network Item Factory 504 may be responsible for creating a network item based on a function instance received from a Function Discovery 505 component. Network Item Factory 504 maintains a collection of network items representing network devices on a given network. A network item object may include device specific information retrieved from other components based on the information contained in a corresponding function instance. For example, Network Item Factory may use a Device Extensibility Registry 509 to provide additional device specific information for the identified devices via a registry entry or via a reference to a device plugin (e.g., a COM component) that may be able to provide device specific information. Network Item Factory 504 may be responsible for implementing a duplicate detection algorithm.

Network Explorer Folder (NEF) 501 may be an object responsible for coordinating underlying components in the architecture to provide a view that may be rendered using a standard Folder View 502. The NEF 501 may communicate with a Network Profile Service 503 to get a list of connected networks. The Network Profile Service 503 may provide a list of connected networks and may enumerate a list of interfaces currently connected to a given network. NEF 501 may be responsible for creating a Folder View 502 for presenting the list of network profiles to a user thereby allowing a user to select a network profile corresponding to a connected network. The Folder View 502 may request NEF 501 for information on each item to be displayed in the Folder View 502. NEF 501 may retrieve the information from the Network Item Factory 504. NEF 501 may then pass a network item collection for a selected network profile to the Folder View 502 for presentation. In one embodiment, NEF 501 may provide representation information (e.g., an icon), context menu information, and property sheet data for each network item.

In one embodiment, the Network Item Factory 504 may retrieve information for a network item from the Device Extensibility Registry 509 based on information in a function instance. Specifically, Network Item Factory 504 may use the IDs in a function instance to find device specific information or device plugins by consulting the Device Extensibility Registry 509. A Device ID is specific to a particular device and may be the first ID searched for in the registry. If a Device ID is not found, then the Network Item Factory 504 may search for a Compatible ID. The Compatible ID may correspond to a more generic class of devices of which the particular device is a member. The registry may enable the claimed network explorer system to provide customization of the display of each device, based on Device ID, or to a group of devices, based on Compatible ID. The customization information may be provided by a manufacturer of a network device through information stored in the registry. Two extensibility models may be defined: basic and advanced extensibility. Registry entries illustrating both models may be illustrated in FIG. 5.

Basic extensibility may not require any code implementation. All the device specific information may be stored in the registry under a generic compatibility ID 601 or a device specific device ID 602. Compatible IDs may correspond to a larger class of devices such as computers 603 and other devices 604, or may correspond to more specific device categories such as printers (not shown). The registry entries may include the location of the icon 605 and customized actions, e.g., through a context menu 606. Other device properties may be stored in a property sheet 607. The Network Item Factory may read the registry to obtain device specific information for displaying the device.

A Device ID 602 may correspond to a specific device such as a printer 608. The Device ID entry may provide device information provided by a manufacturer of the device. The entry may include a manufacturer provided icon 609, context menu 610 and a property sheet 611.

Advanced extensibility may require a device to provide an object that implements a set of standard interfaces and add a registry entry under the Device ID to point to the object 612, thereby providing dynamic updates of device specific information. Some existing browsing systems may provide only a uniform representation of each discovered device, thereby sacrificing device specific information for consistency, and further reducing presentation utility. Extensibility through device plugins may enable customization of the representation of discovered network devices and a set of options for interacting with a network device.

In one embodiment, the device plugin referenced by the registry may return different icons based on whether the device is busy or not. When the state of the device changes, the device plugin may use a callback function to notify the NEF 501 (FIG. 5) to update the representation of an item. Alternatively, where a context menu may provide a user interaction options, those options may change when device state changes.

While certain devices may be detectable, a computer may not be able to immediately access device functions because the computer may not be equipped with the proper software drivers. In this case, registry information may simply reference the appropriate device drivers on a computer and provide an option to install them. Alternatively, the registry may provide other installation options. For example, where the drivers are not contained on the computer, an installation option may be to start an installation wizard which is capable of retrieving the necessary drivers from the Internet or other sources.

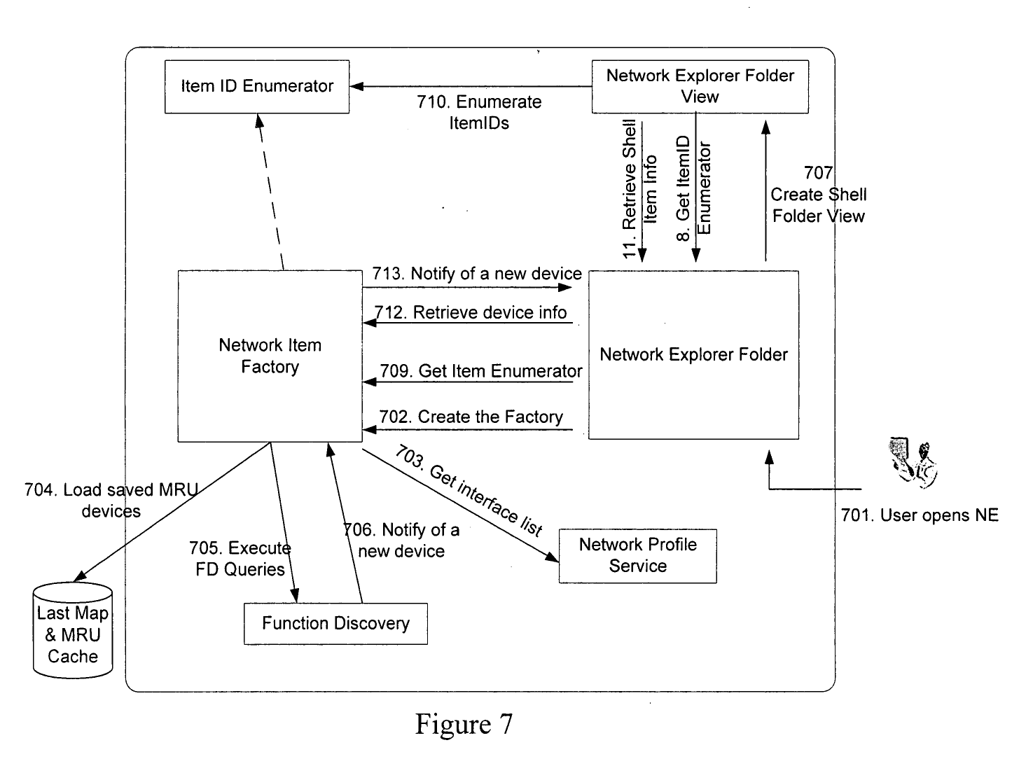

A network explorer process flow diagram is illustrated in FIG. 7.

In block 701, a user may open a root network explorer Folder that, upon selection of a network profile, may create a new network explorer Folder specific to the selected network profile. A Network Item Factory 504 (FIG. 5) object may be created to enumerate network devices while the network explorer Folder is initialized.

In block 702, upon association of a network specific instance of the NEF 501 (FIG. 5) with a Network Item Factory 504 (FIG. 5), the Network Item Factory 504 may begin to enumerate devices on a given network.

In block 703, the Network Item Factory 504 receives a list of interfaces for a selected network from the Network Profile Service 503.

In block 704, the Network Item Factory 504 may load a Most Recently Used (MRU) device information for a network profile from a cache. In one embodiment, the MRU is used to cache the last device collection information for a particular network profile. MRU may enable cached, but subsequently removed/unconnected devices to be indicated on the folder view as unconnected (e.g., using a grayed out icon of the non-connected device). Logic may be included to determine how long an icon may persist in the network item view, thereby determining the duration of the display of that device icon in the Folder View 502 (FIG. 5). In one embodiment, the icon may be removed after a second update of device information. Specifically, the device may be removed from the list and view after the second time a discovery process determines that the device is unconnected. In an alternative embodiment, there may be no caching function. In this case, the network explorer may only display a current list of connected devices for a profile.

In block 705, the Network Item Factory 504 may begin querying Function Discovery (FD) 505 to discover network devices. This is an asynchronous process, and occurs in parallel with the rest of the process described below. In an alternative embodiment, LLTD may be a separate component managed by the Network Item Factory 504, instead of being a component managed by Function Discovery 505.

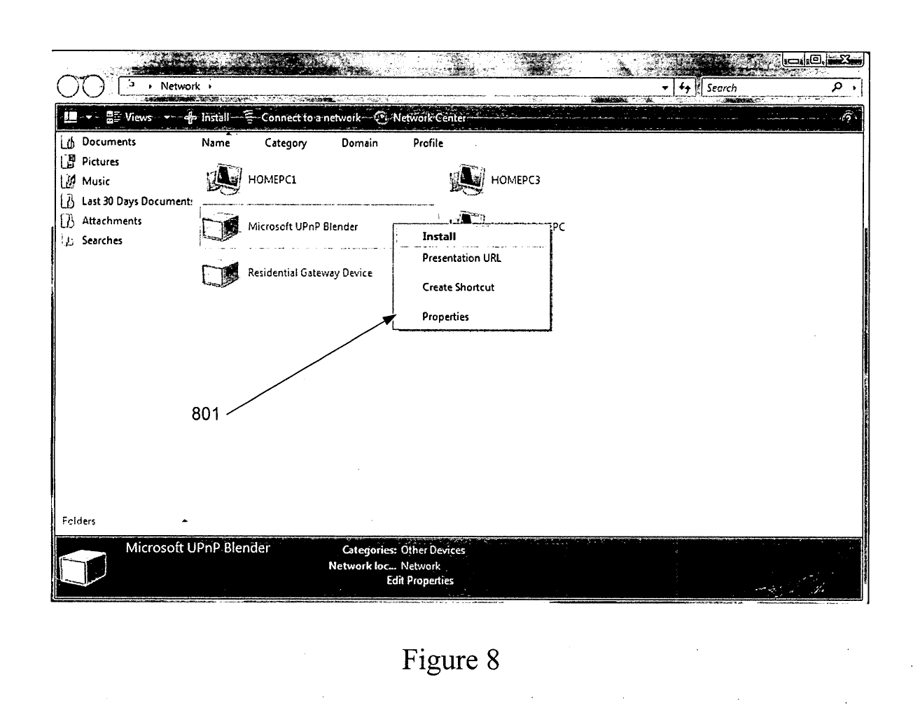

In block 706, function instances are returned as the result of the discovery process. Network Item Factory 504 may create network items based on the function instances. As discussed above, a network item may provide customized actions, icons and properties based on the settings in the registry located using first a device ID, and then a compatible ID. Moreover, the customization may be different based on whether the device is installed. For example, as illustrated in FIG. 8 if a device is not installed, an “Install” menu item 801 may be added to the context menu. In this embodiment, Network Item may use a lazy initialization of the device plugin, e.g., only when new requests for visual information of a device may the network item initialize the device plugin and query for the requested information.

In block 707, the NEF 501 may create a standard Folder View 502.

In block 708, Folder View 502 may request an item enumerator from the NEF 501.

In block 709, NEF 501 may query the Network Item Factory 504 for a Network Item Enumerator, which includes a collection of current items, representing the current set of known devices. The Enumerator may only contain a collection of references to network items (each view item ID corresponding to a network item), not the collection of the network items themselves. When there is a device change (e.g., add, remove or property change), Network Item Factory 504 may use a call back function to notify the NEF 501 and Folder View 502 that some view item has changed. Based on the collection of references the NEF 501 and Folder View 502 receives, the view can retrieve the latest device information from Network Item Factory 504 and update the Folder View 502 accordingly.

In block 710, the Folder View 502 may query the Enumerator for the collection of references for all the view items contained in the folder.

In block 711, the Folder View 502 may query the NEF 501 for specific information (e.g., icon, context menu, and/or property sheet) for a view item reference.

In block 712, NEF may query Network Item Factory 504 to return device specific icon, actions and properties. All the device specific information may be created only upon request, e.g., when the information is requested by the view. Before returning the results to the view, additional default actions and properties may be added, such as “Create shortcut” and “Properties”, before passing the information to view. When the user selects an action, a device specific application may be launched and a function instance ID may be passed to the application as an input parameter. This may allow the device specific application to uniquely identify the network devices. Note, because a query for network devices may take a long time, FD 505 queries may be made asynchronous. This may allow NEF 501 to access Network Item Factory 504 while FD 505 query updates. In one embodiment, Network Item Factory 504 may be guarded with a data lock to prevent concurrency problems.

In block 713, when a new device is detected after block 707, the Network Item Factory 504 may notify the Folder View 502, which then causes the Folder View 502 to redraw.

Duplicate Detection

When using a multiple protocol approach to device discovery, a single device may be detected multiple times using different protocols. Duplicate listings of a single device may only confuse a user and thus an intuitive user interface such as network explorer may implement a duplicate detection algorithm. In a first scenario, a device may announce its service using multiple protocols. For example, a printer may announce the printing service using SSDP, WS-D and Browser, separately. Because the device ID, name, MAC, and IP address may be the same in any protocol used, the algorithm may search for these parameters and eliminate duplicate entries, thereby presenting only a single device in a network explorer view.

In another situation a device may be a multi-homed device, such as a PC that is connected to two Local Area Networks at the same time. In this situation, the MAC address and IP address may be different between two function instances, but the device ID and the name will be the same, and hence the detection algorithm may base its determination on the device ID and name and still show only one device.

A multifunction device may announce each of its functions using separate service announcements. In one embodiment, multifunctional devices may be provided the option to advertise themselves as a composite device or as multiple independent devices (one for each function). In this case, the device ID and name may be different, but the MAC and IP address may be the same. If the duplicate detection algorithm determines that they should be treated as independent devices, the device may be presented in network explorer as separate items, e.g., with different device specific information such as Icon and Context Menu. The composite device may be provided a context menu including a set of options for each function of the multifunction device.

1. A method in a computer system of displaying on a display device a network device discovery result, the method comprising:
providing a discovery result that includes a list of devices discovered through a plurality of network discovery protocols, at least one identifier for each device, and state information for each device;
displaying on the display device a representation of each device of the list of discovered devices;
indicating a state of each of the set of discovered devices via the representation, wherein the state is based on the state information; and
upon selecting one device of the set of discovered displayed devices, indicating interaction options for the selected device based on context information derived through the at least one identifier.

2. The method of claim 1, wherein the plurality of network device protocols comprises at least one of SSDP, UPnP, WS-Discovery, NetBIOS, Master Browser, and WINS.

3. The method of claim 1, wherein the at least one identifier comprises at least one of a hardware ID and a compatibility ID.

4. The method of claim 1, wherein the state information comprises one of a connection status indication and installation indication.

5. The method of claim 1, further comprising deriving a device type from the at least one identifier and wherein the representation of each device of the list of discovered devices is based on the device type.

6. The method of claim 1, wherein the representation of at least one device of the represented devices is based on an entry in a computer system registry corresponding to the identifier of the device.

7. The method of claim 6, wherein the entry comprises an extension that is used to dynamically change the representation of the one device based on a context of the one device.

8. The method of claim 7, wherein indicating interaction options comprises displaying a context menu visually associated with the selected device, the context menu providing a list of actions based on one of a hardware ID and compatibility ID.

9. The method of claim 1, further comprising detecting duplicate device listings and enumerating only a single entry for a set of duplicate devices to provide a discovery result.

10. The method of claim 1, wherein providing a discovery result comprises detecting multiple function devices and enumerating one of a separate device listing for each function of a single multiple function device and multiple device listings, one for each function of the single multiple function device.

11. The method of claim 1, wherein providing a discovery result comprises using the discovery protocols to query for existing network devices and returning a portion of a result of the query before the query is complete.

12. The method of claim 1, wherein providing a discovery result comprises providing a previously cached discovery result.

13. The method of claim 12, further comprising displaying on the display device a representation of each device of the previously cached discovered result and updating each representation when a new discovery result is provided.

14. The method of claim 1, further comprising displaying a network profile identifier for identifying a set of displayed representations of discovered devices.

15. The method of claim 14, wherein providing a discovery result is based on a network profile associated with a network connection of the computer system and a cache associated with the network profile.

16. The method of claim 15, wherein the network profile is based on a network connection and a user, and wherein the network profile is used to determine whether a portion of the provided discovery result is withheld from being displayed.

17. A computer system for displaying a plurality of representations of network devices, discovered over a plurality of discovery protocols, the representations indicating state information and interaction information for each discovered network device, the system comprising:
a function discovery component that detects network devices using a plurality of discovery protocols and provides a list of discovered network devices, including a state parameter and at least one identifier for each discovered device;
a registry for mapping interaction information with a device identifier and representation information with a state parameter;
a graphical user interface that displays a representation of each of the listed network devices on a display based on the at least one state parameter and the registry, and upon receiving a signal indicative of the user interface device selecting a network device representation on the display, displaying a set of interaction options associated with the selected device based on the state parameter, the at least one identifier, and the registry.

18. The computer system of claim 17, wherein the function discovery component provides a cached list of discovered network devices upon instantiation of the component and continuously provides an updated list of network devices as detection occurs.

19. The computer system of claim 18, wherein the graphical user interface dynamically changes the representations of the network devices based on the state parameters and registry.

20. A display device having rendered thereon a set of discovered network devices, comprising:
an icon representing each discovered network device of a network profile; and
a selectively displayable context menu associated with each icon,
wherein a state of each discovered network device is represented via the icon, which is dynamically changed based on one of a state parameter and a device identifier; and
wherein the context menu is dependent on at least one of the state parameter and an interaction specification of the device determined by a registry and the device identifier.
